(19) United States
(12) Patent Application Publication
(10) Pub. No.: US 2006/0169764 A1
(43) Pub. Date: Aug. 3, 2006

(54) Self-service terminal

(75) Inventors: Gary A. Ross, Edinburgh (GB); Barrie Clark, Dundee (GB)

Correspondence Address: MICHAEL CHAN;NCR CORPORATION, 1700 SOUTH PATTERSON BLVD, DAYTON, OH, 45479-0001, US

(73) Assignee: NCR Corporation

(21) Appl. No.: 11/273,482

(22) Filed: Nov. 14, 2005

(30) Foreign Application Priority Data
Jan. 28, 2005 (GB) 0501824.7
Jul. 29, 2005 (GB) 0515597.3

(51) Int. Cl. G06F 17/00; G07F 19/00

(52) U.S. Cl. 235/375; 235/379

(57) ABSTRACT

A self-service terminal (SST) comprises: a first sensor for sensing a first condition at the SST and a second sensor for sensing a second condition at the SST. The conditions may relate to environmental characteristics, such as humidity or temperature; general characteristics; specific characteristics of the SST; or characteristics of fraudulent devices. The SST also has a memory for storing reference data indicative of conditions at the SST, where at least some of the stored reference data is indicative of conditions during normal operation. The SST has a processor coupled to the first sensor, the second sensor and the memory, where the processor is operable to (i) receive captured data from the sensor, (ii) retrieve the reference data from the memory, and (iii) compare the captured data with the reference data to determine if the captured data is indicative of abnormal conditions.

The present invention relates to a self-service terminal (“SST”).

### BACKGROUND

A SST is generally defined as a device that is suitable for allowing a user to conduct a transaction or to access information in an unassisted manner (that is, without requiring help from a human) and/or in an unattended environment (that is, an area that is not supervised by someone to ensure that the SST is not being misused). An SST deployer may decide to provide human assistance and/or supervision for users of the SST; however, SSTs are typically designed so that such assistance and/or supervision is not essential.

Complex SSTs typically include a controller having components commonly used in a personal computer (PC); however, SSTs differ substantially from general-purpose computing devices (such as PCs) and, therefore, a general-purpose computing device is expressly excluded from the definition of an SST. Furthermore, PCs are generally used in non-public locations, such as homes and offices, where access to the PCs can be restricted to people who can be trusted. In contrast, SSTs are typically situated in public locations for use by a large number of people. Being publicly accessible, there is a risk that SSTs will be subject to physical or electronic attack, for example, as part of an attempted fraud. To ensure that SSTs are not compromised, SSTs typically include some form of tamper resistance to reduce the possibility of members of the public being able to interfere with the operation of the SST.

One common type of SST is an automated teller machine (“ATM”). To conduct a transaction at a conventional ATM, a user presents to an ATM an identification token, typically in the form of a magnetic stripe card. In such an ATM, a user inserts his magnetic stripe card into a card reader slot in the ATM fascia. The user then typically verifies his identity, for example, by entering a personal identification number (“PIN”) associated with the card, but known only to the user. The PIN is entered via an encrypting keypad incorporated in the ATM. Thus, both card information (from the magnetic stripe), and PIN information (entered by a user) are required to gain access to an account. Once access to the account is obtained the user conducts a transaction. In a typical transaction a user selects an amount of currency to withdraw from the ATM. The ATM then dispenses the currency to the user through a cash dispensing slot and the user's account is debited by the amount of the currency.

If an unauthorized individual, such as a fraudster, wishes to gain access to an account belonging to the user and thus make unauthorized withdrawals of funds, it is necessary for the fraudster to obtain the card information and PIN information from the user.

Card information can be obtained either (i) surreptitiously from the card (for example, using a skimming device located in the vicinity of the card reader slot and that reads the magnetic stripe as it is inserted into or removed from the ATM) or (ii) by obtaining the actual card itself (for example, by trapping the card in the ATM for later retrieval by the fraudster).

PIN information may be obtained either (i) by observing the user as he enters his PIN (either by the fraudster or an accomplice standing beside the user as he enters his PIN, or by a camera fitted to the fascia by the fraudster and directed to the keypad), or (ii) by recording keystrokes via a keypad overlay that the fraudster has fitted over the keypad.

Therefore, potential points of attack on an ATM include the card reader slot, and the encrypting keypad, both of which may be fitted with false user interface components to intercept data as it is being communicated to the ATM. Once the fraudster has obtained the user's PIN he can use the PIN in conjunction with either (i) a fraudulent card created using details skimmed from the genuine card or (ii) the genuine card if a trapping device was used, to withdraw funds from the account of the user. These withdrawals may continue for an extended period before the user notices the fraudulent use of his card.

Any other data capture device (such as a biometric reader) provided on an ATM may have a false user interface component fitted thereto by a fraudster.

A fraudster may also attack an ATM by fitting a false user interface component over the ATM's cash dispensing slot. This false user interface component captures currency as it is dispensed by the ATM so that the user is not aware that the currency has been dispensed. The user typically assumes that the ATM has failed to dispense the currency and abandons the ATM. The fraudster can then retrieve the currency from underneath the false user interface component.

### SUMMARY

It is among the objects of one or more embodiments of the present invention to provide an SST that reduces the risks of such frauds or otherwise reduces or mitigates problems with prior art SSTs.

According to a first aspect of the present invention there is provided a self-service terminal (SST) comprising: a first sensor for sensing a first condition at the SST; a second sensor for sensing a second condition at the SST; a memory for storing reference data indicative of conditions at the SST, where at least some of the stored reference data is indicative of conditions during normal operation; and a processor coupled to the first sensor, the second sensor and the memory, where the processor is operable to (i) receive data from the sensors, (ii) retrieve the reference data from the memory, and (iii) compare the received data with the reference data to determine if the received data is indicative of abnormal conditions.

A condition may relate, inter alia, to: (i) the general environment, and/or (ii) a specific environment, and/or (iii) a user environment, and/or (iv) the climatic environment, and/or (v) a fraudulent environment.

Conditions indicative of normal operation of the SST indicate that fraud is not suspected.

Abnormal conditions are conditions that do not correlate with or match conditions during normal operation. As a result, abnormal conditions indicate that fraud is suspected.

Preferably, when abnormal conditions are determined to be present at the ATM the processor is operable to calculate the probability that fraud is occurring. Based on the calculated probability the processor can execute any of a number of security procedures. For example, one security procedure may cause an alert signal to be sent to a control center indicating that the SST may be a target for fraud. This alert signal may also be accompanied by the calculated probability so that a remote entity (a human or a machine) can assess the severity of the situation and take action accordingly. Another security procedure may deactivate the SST.

The SST may further include a camera for imaging at least part of the SST. The camera may be operable to (i) capture an image of the part of the SST from where the sensor captured data indicative of the abnormal condition, and (ii) relay the image to a location remote from the SST.

Providing an image of part of the SST may allow an operator (or a computer) at a remote site to view the image and make a conclusive determination of whether fraud is present at the SST. If fraud is not present, the operator may restore the SST to normal service.

Preferably, the sensor may be operable to detect a number of different frequencies so the sensor can differentiate between moisture being sensed and physical objects, for example, plastics, metal, ceramic, or such like. Moisture is only sensed at some frequencies, not other frequencies, so by sensing at multiple frequencies the system can differentiate between moisture and physical objects.

According to a second aspect of the present invention there is provided an SST comprising: a user interface; sensors distributed across a fascia of the user interface, the sensors being operable to detect foreign objects placed at the user interface; a memory for storing reference data, wherein the reference data is indicative of known conditions at the self-service terminal that could possibly occur; and a processor coupled to the sensors and the memory, where the processor is operable to (i) receive captured data from the sensors, (ii) analyze the captured data in view of the reference data to determine a probability that a foreign object is detected, and (iii) evaluate whether the foreign object is a fraudulent device.

As used herein, a foreign object is an article that is not part of the SST but is brought into the vicinity of the SST.

Preferably, at least some of the sensors are operable to monitor areas on the self-service terminal where attacks are most likely (such as the area around the card reader and the keypad), and other sensors are operable to monitor the general environment at the self-service terminal.

As used herein, the general environment refers to characteristics such as lighting intensity, background noise level, radio signal strength, vibration, and the time, the duration, the rate and/or the frequency at which any of these phenomena occur or change, and such like.

According to a third aspect of the present invention there is provided a fraud detection system comprising a memory for storing reference data, where the reference data is indicative of conditions at the SST at some previous time; a plurality of sensors disposed at a self-service terminal, where the plurality of sensors are located for detecting foreign objects at the SST; and a processor coupled to the memory and each of the plurality of sensors, wherein the processor is operable to (i) receive the reference data from the memory, (ii) receive the captured data from each of the plurality of sensors, and (iii) analyze the reference data and the captured data to determine the probability that an object detected by one or more of the plurality of sensors is a fraudulent device.

The foreign object may be a fraudulent device. Alternatively, the foreign object may be an article that is brought into contact with the SST accidentally, such as a finger ring on a user's hand when the user enters his PIN, or a small object blown onto the SST by a gust of wind.

According to a fourth aspect of the present invention there is provided a fraud prevention apparatus for use with a self-service terminal, the fraud prevention apparatus comprising a data capture device, means for storing reference data, means for detecting the presence of a foreign object at the data capture device and capturing data indicative thereof, and means for analyzing the reference data and the captured data to determine the probability that a detected foreign object is a fraudulent device.

The fraud prevention apparatus may also include actuatable means for producing an alarm signal when the probability that a detected foreign object is a fraudulent device is high.

According to a fifth aspect of the present invention there is provided a method of detecting fraud at a self-service terminal, the method comprising: (i) capturing data indicative of a foreign object from a sensor disposed at the self-service terminal, (ii) obtaining reference data from a memory, and (iii) analyzing the captured data and the reference data to determine if the foreign object is a fraudulent device.

The method may comprise the further step of generating an alert signal in response to determining that the detected foreign object is a fraudulent device.

Alternatively, or additionally, the method may comprise the further step of executing a security protocol in response to determining that the foreign object is a fraudulent device.

According to a sixth aspect of the present invention there is provided a method of detecting operating conditions at a self-service terminal, the method comprising the steps of: monitoring an environmental condition of the self-service terminal using a plurality of sensors; receiving data from the plurality of sensors; and comparing the received data with reference data to determine the probability that the monitored environmental condition is indicative of fraud.

Preferably, the reference data at least partly comprises data that is indicative of normal use and normal environmental variations.

In many embodiments, normal use and normal environmental variations change over time (that is, they are dynamic), so the reference data that is indicative of normal use and normal environmental variations is also dynamic to track these changes.

Preferably, the reference data that is indicative of normal use and normal environmental variations at least partly comprises data that is captured by the plurality of sensors on a continual basis to provide a current state of normal use and normal environmental variations.

The step of comparing the received data with reference data may include factoring out any data that is indicative of normal use and normal environmental variations.

The method may include the further step of selecting a security protocol based on the probability that the monitored environmental condition is indicative of fraud.

According to a seventh aspect of the present invention there is provided a computing device comprising: a first sensor for sensing a first condition at the device; a second sensor for sensing a second condition at the device; a memory for storing reference data indicative of conditions at the device, where at least some of the stored reference data is indicative of conditions during normal operation; and a processor coupled to the first sensor, the second sensor and the memory, where the processor is operable to (i) receive data from the sensors, (ii) retrieve the reference data from the memory, and (iii) compare the received data with the reference data to determine if the received data is indicative of abnormal conditions.

According to an eighth aspect of the present invention there is provided a SST network comprising: a plurality of SSTs, each SST including one or more sensors for sensing conditions at the SST; a remote status manager coupled to the SSTs for (i) receiving sensed conditions from sensors in the SSTs, (ii) comparing the sensed conditions with reference data, and (iii) determining if the received sensed conditions are indicative of abnormal conditions at any of the plurality of SSTs.

It will now be appreciated that aspects of the present invention encompass an anti-fraud arrangement that can be included within an SST or distributed across one or more SST networks.

### BRIEF DESCRIPTION OF THE DRAWINGS

These and other aspects of the invention will be apparent from the following specific description, given by way of example, with reference to the accompanying drawings, in which:

FIG. 1 is a block diagram of an SST (in the form of an ATM) in accordance with an embodiment of the invention;

FIG. 2 is a schematic diagram of the fraud detection system included in the SST of FIG. 1;

FIG. 3 is a schematic side view of part of the SST (the card reader) of FIG. 1;

FIGS. 4A and 4B are schematic plan and side views respectively of another part of the SST (the keypad) of FIG. 1;

FIG. 5 is a flow chart illustrating steps of a fraud detection process performed by the fraud detection system of FIG. 2;

FIG. 6 is a schematic diagram of part of a SST (the terminal controller) in accordance with another embodiment of the present invention; and

FIG. 7 is a schematic diagram of an SST network in accordance with yet another embodiment of the present invention.

### DETAILED DESCRIPTION

Retro-Fitted ATM Embodiment

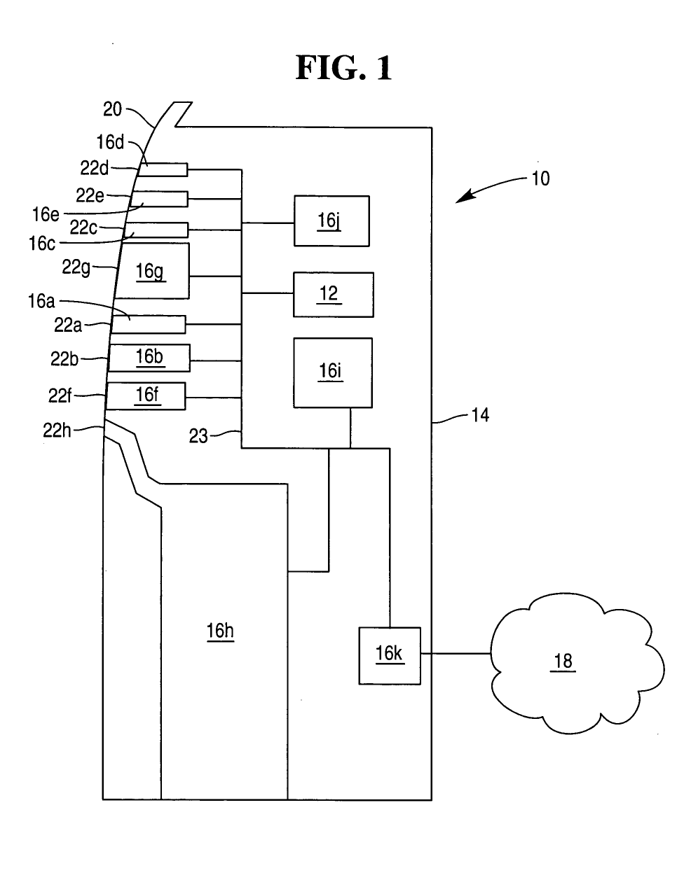

Referring to FIG. 1, there is shown a schematic diagram of an SST 10 in the form of an ATM in accordance with an embodiment of the present invention. Suitable ATMs include the Personas (trade mark) range of ATMs available from NCR Corporation, 1700 S. Patterson Blvd., Dayton, Ohio, 45479, USA.

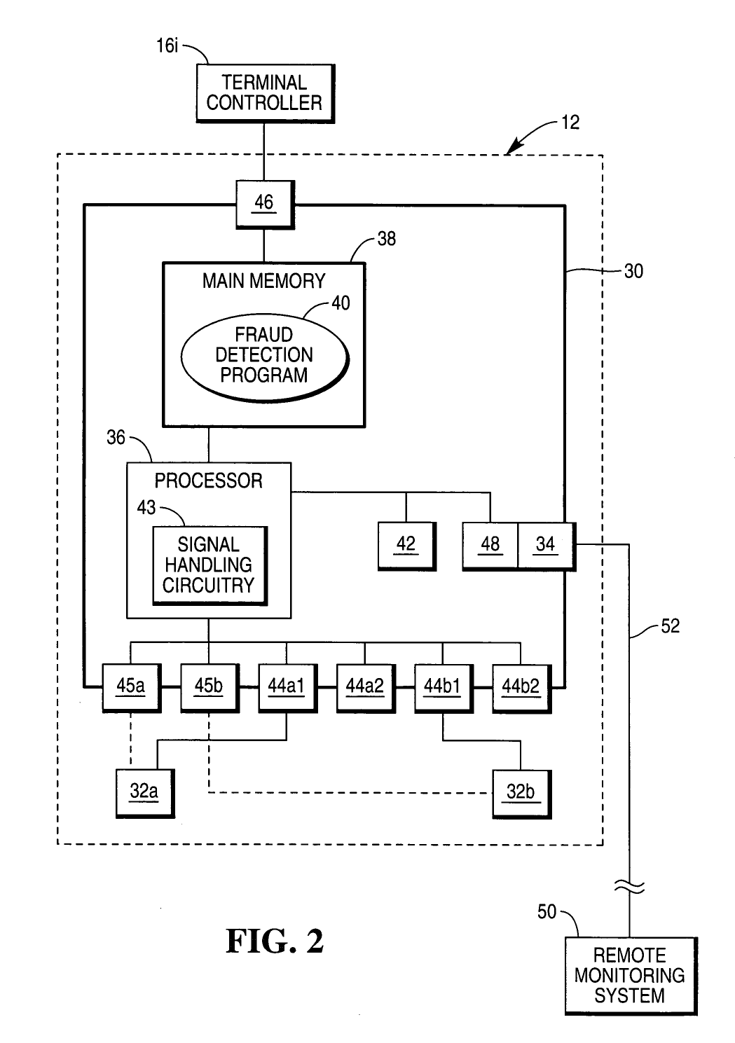

The ATM 10 includes a fraud detection system 12, which is shown in more detail in FIG. 2. The fraud detection system 12 monitors the ATM 10 and generates an alarm in the event of fraud being detected. In the ATM 10, the fraud detection system 12 has been retrofitted subsequent to the installation of the ATM 10. The fraud detection system 12 is a stand alone system receiving power from the ATM 10 which it monitors (as described in more detail below), but is in other respects independent thereof.

The ATM also includes a housing 14, in which the fraud detection system 12 and ATM components 16 are mounted. The components 16 include user interface components 16a-h, and operational components 16i-k. The operational components 16i-k comprise a terminal controller 16i for controlling the operation of the ATM 10, a journal printer 16j for recording transactions fulfilled by the ATM 10, and a network connection 16k (in the form of a modem or network card) for connecting the terminal controller 16i to an external network 18. This external network 18 may be any public network or private ATM network suitable for transmitting and receiving data, but in this embodiment, a private network is used for improved security.

The ATM 10 also has a fascia 20 movably coupled to the housing 14, such that the fascia 20 can be moved from a closed position, where user interface locations 22 in the fascia 20 align with respective user interface components 16a-h, to an open position, which allows the ATM components 16 to be accessed for servicing, replenishment, and such like.

User interface locations 22a-c and 22e-g comprise apertures which extend through the fascia 20 from a front of the fascia 20 (which is accessible to a user of the ATM 10) to a rear of the fascia 20 (which abuts some of the user interface components 16a-h in the housing 14).

The user interface locations 22a-h and components 16a-h together form a user interface that allows a user to enter a transaction at the ATM 10. These user interface components 16a-h include data capture devices 16a-e, a receipt printer 16f, a display 16g, and a cash dispenser 16h. The data capture devices 16a-e include an encrypting keypad 16a, a magnetic stripe card reader 16b, function display keys (FDKs) 16c disposed adjacent to each of two opposing vertical sides of the display 16g, an RFID receiver 16d, and a biometric reader 16e.

In this embodiment, all of the user interface components 16a-h are mounted in the housing 14 and located so that when the fascia 20 is in the closed position, each of the user interface components 16a-h is in registration with a respective one of the user interface locations 22a-h. For example, the encrypting keypad 16a is in registration with an aperture defined by the fascia 20 at user interface location 22a, and is thus accessible through the aperture (which corresponds to user interface location 22a). Similarly, the card reader 16b is in registration with an aperture (a slot) defined by the fascia 20 at user interface location 22b and receives a card inserted through this slot (which corresponds to user interface location 22b).

The user interface components 16a-h are interconnected to the operational components 16i-k via a bus 23 (or a plurality of buses) to allow mutual intercommunication of the components within the ATM 10.

The terminal controller 16i controls the operation of the other ATM components 16. In this embodiment most of these ATM components 16 have their own processors for performing state of health functions, for operating on received data and for performing the specific functions of that component.

Reference is now also made to FIG. 2, which shows the fraud detection system 12 in more detail.

The fraud detection system 12 comprises: a fraud detection circuit board 30 (in the form of a card); sensors 32a,b removably coupled to the fraud detection card 30; and a wireless communication device 34 in the form of a cellular radio-frequency transceiver (hereinafter an “rf transceiver”) removably coupled to the fraud detection card 30.

The fraud detection card 30 includes a processor 36 having an associated memory 38 for executing a fraud detection program 40 loaded from a non-volatile memory 42.

The fraud detection card 30 is also equipped with four transmitting channels 44a₁, 44a₂, 44b₁, and 44b₂ and two receiving channels 45a-b which are coupled to the sensors 32a,b to enable the card 30 to receive signals therefrom. Each sensor 32 is coupled to one transmitting channels 44 and one receiving channel 45. For example, sensor 32a is coupled to transmitting channels 44a₁ and receiving channel 45a. As shown in FIG. 2, the transmitting channels 44a₂ and 44b₂ are not utilized. These extra transmitting lines are provided on card 30 so that additional sensors may be connected at a later time.

Signal handling circuitry 43 is provided at the processor 36 to manage the transmitting channels 44 and the receiving channels 45. The signal handling circuitry 43 enables the processor 36 to send data to and receive data from the sensors 32. To achieve this, the signal handling circuitry 43 includes circuitry for converting signals between analog and digital.

The signal handling circuitry 43 uses time division multiplexing to enable each sensor 32 to monitor the ATM 10 at two different frequencies. For example, in a first time slot (t1) the signal handling circuitry 43 transmits a signal to the sensor 32a at a first frequency (f1) and in a second time slot (t2) the signal handling circuitry 43 transmits a signal to the senor 32a at a second frequency (f2), which is different from f1. The signal handling circuitry 43 sequentially receives data signals back from the sensor 32a. In t1 the signal handling circuitry 43 receives from the sensor 32a a first data signal (ds1) corresponding to f1 and in t2 a second data signal (ds2) corresponding to f2 is received.

Using the fraud detection program 40, the processor 36 operates on each individual data signal (ds1 then ds2) to determine if fraud is suspected at the ATM 10. This process is concurrently carried out for each sensor 32. In each sequential time slot the processor 36 receives two data signals, one from each sensor 32.

Multiple frequencies are used by a single sensor 32 to differentiate between different types of material. This is possible because two types of material may respond similarly at a first frequency, but differently at a second frequency. The use of two frequencies allows the identity of a material detected at the ATM 10 to be determined with a greater degree of probability.

It should be appreciated that the fraud detection system 12 may be operated in a single frequency mode where each sensor monitors the ATM 10 at only one frequency.

The fraud detection card 30 is also coupled to a miscellaneous interface port (not shown) in the terminal controller 16i via an interface port 46. This miscellaneous interface port (not shown) is typically provided on NCR (trade mark) ATMs to allow a device to connect to the terminal controller 16i in the event of a requirement to upgrade the ATM by retro-fitting a new device. In this embodiment, the interface port 46 is used primarily to convey power from the terminal controller 16i to the fraud detection card 30, but in other embodiments the fraud detection card 30 may communicate data to and/or from the terminal controller 16i.

The processor 36 is coupled to the rf transceiver 34 via a remote monitoring centre port 48. The processor 36 is programmed to dial a remote monitoring center 50 to convey information thereto. This allows the fraud detection system 12 to communicate with the center 50 and relay information about suspected ATM fraud thereto. By dialing a telephone number of the center 50 the rf transceiver 34 creates a direct communication channel 52 such that the fraud detection system 12 has a dedicated channel for alerting the center 50 and/or any other suitable entity to a possible attack on the ATM 10.

The sensors 32 are in the form of capacitive proximity sensors. Sensor 32a monitors the encrypting keypad 16a (hereinafter “keypad sensor 32a”) and sensor 32b monitors the card reader 16b (hereinafter “card reader sensor”).

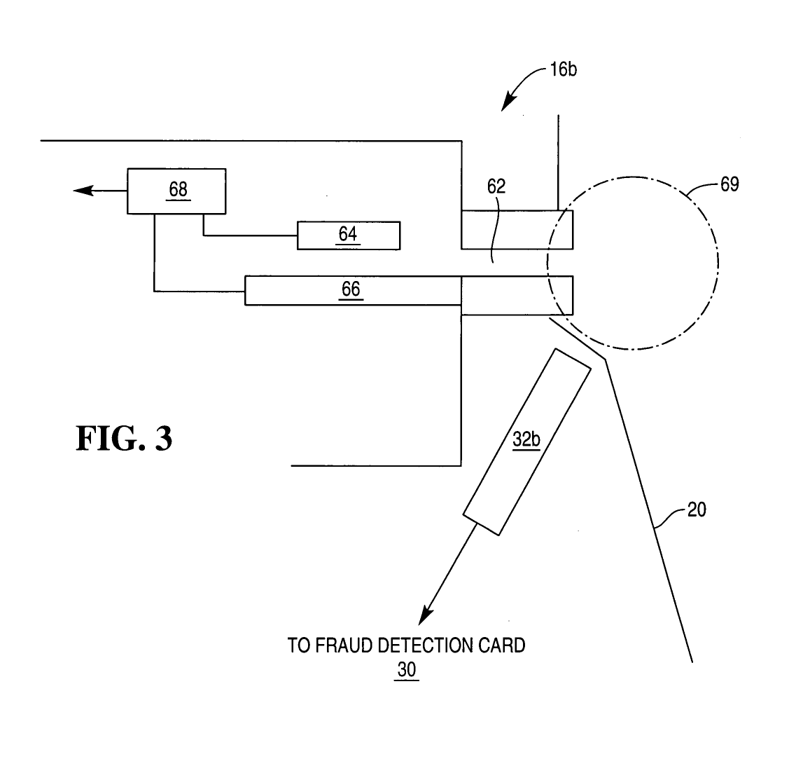

Referring also to FIG. 3, there is shown a simplified schematic diagram of a portion of the ATM 10, including the card reader 16b, a portion of the fascia 20 and the card reader sensor 32b.

The card reader 16b is a conventional card reader such as a motorized card reader module available from Sankyo Seiki (Trade Mark) at 1-17-2, SHINBASHI, MINATO-KU, TOKYO, 1058633, Japan. The card reader 16b defines a card reader throat 62 in registration with the aperture 16b in the fascia 20. The throat 62 is dimensioned to receive a card and guides the card towards a card reader head 64 within the card reader 16b.

Card reader 16b includes a pair of rollers (not shown) to guide an inserted card onto a transport mechanism 66, which conveys the card between the throat 62 and the card reader head 64. The card reader head 64 and the transport mechanism 66 are both controlled by a dedicated card reader controller 68.

The card reader sensor 32b is located adjacent to the fascia 20 so that the card reader sensor 32b can detect foreign objects (such as third party card reader devices) placed in contact with or in close proximity to the card reader throat 62. This area which is monitored by card reader sensor 32b is illustrated in FIG. 3 by a dotted-line circle 69. In this embodiment the card reader sensor 32b is coupled to, controlled, and monitored by the fraud detection card 30.

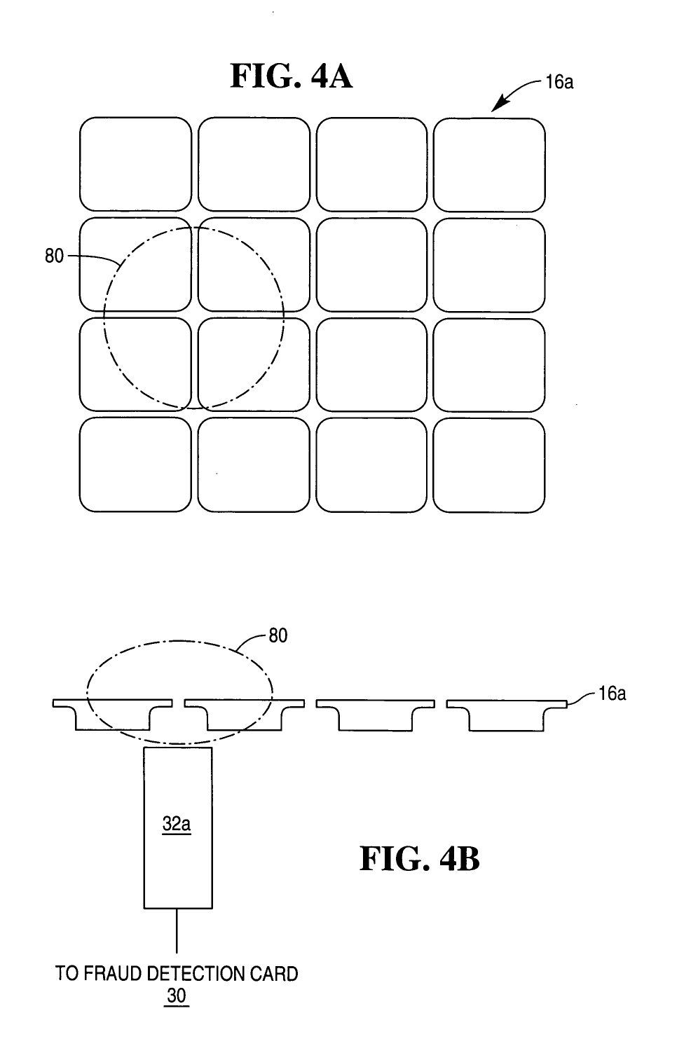

FIGS. 4A and 4B show part of the ATM 10 in more detail, namely the encrypting keypad 16a and the keypad sensor 32a located thereunder.

The keypad sensor 32a monitors the encrypting keypad 16a and sends data to the fraud detection card 30. The area detected by keypad sensor 32a is illustrated in FIGS. 4A and 4B by dotted-ellipse 80. The fraud detection card 30 operates on the data received from the keypad sensor 32a to determine if a fraudulent device, such as a keypad overlay, is present at the ATM 10.

It will be appreciated that in the embodiments of FIG. 3, FIG. 4A and FIG. 4B the areas detected by the sensors 32 are areas liable to attack by a foreign device; that is, an area over which a foreign device may be placed.

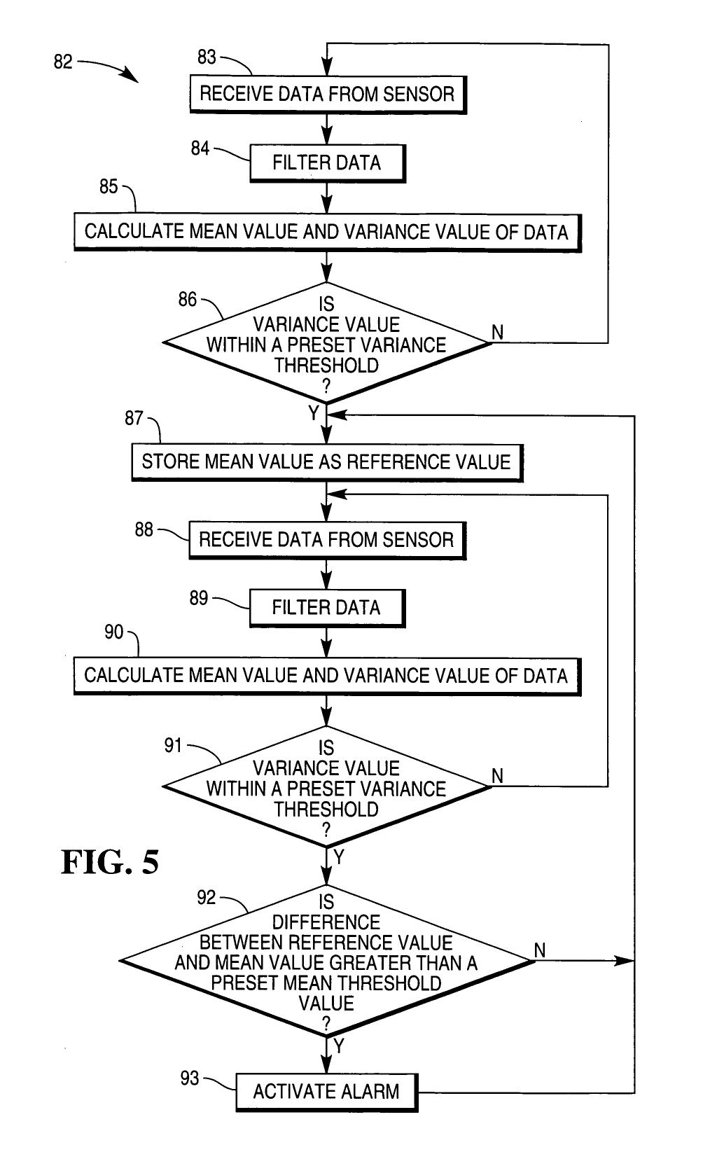

Reference is now made to FIG. 5, which is a flow chart illustrating the fraud detection process 82 performed by the processor 36. It will be appreciated that the same fraud detection process 82 is utilized to process the data signals received from each of the capacitive proximity sensor 32a or 32b, though for purposes of simplicity the fraud detection process 82 will be discussed with reference to the keypad sensor 32a.

Once the fraud detection system 12 is powered up and the fraud detection program 40 is loaded into the main memory 38 the fraud detection system 12 begins to monitor the sensor 32a. In an initial data receiving step 83, the processor 36 receives a data signal from the keypad sensor 32a for a preset period of time, such as one second. Following the receipt of this initial data signal, the processor 36 filters high frequency transients from the data signal in data filtering step 84. These high frequency transients are often produced by portable cellular radio-frequency telephones and other RF noise sources in the local environment of ATM 10.

After the data has been filtered, the fraud detection process 82 proceeds to a statistical calculation step 85 where the filtered data signal is used to calculate a mean value and a variance value. The variance value is a measure of the data signal's stability. A stable data signal enables the fraud detection system 12 to operate with a high degree of accuracy. For example, hand movement at the encrypting keypad 16a may cause large fluctuations in the data signal, i.e. an unstable data signal, which can result in an inaccurate determination of fraud by the fraud detection system 12.

Once the calculations are performed, the process 82 proceeds to a variance threshold analysis step 86. In this step, the processor 36 determines if the variance value is within a predetermined variance threshold. The variance threshold is preset by a system administrator. If the variance value is not within the variance threshold all the data associated with that particular data signal is discarded and the fraud detection process 82 returns to the initial data receiving step 83.

Conversely, if the variance value is within the variance threshold the fraud detection process 82 proceeds to the storing reference value step 87, where the mean value calculated in the statistical calculation step 85 is stored as a reference value in the main memory 38. Reference values that are calculated from data signals that are stable will typically result in accurate readings by the fraud detection device 12, therefore, the variance threshold analysis step 86 is crucial to calculating a reliable reference value.

Once a reference value has been established, the fraud detection process 82 proceeds to a current data receiving step 88, where the processor 36 receives a data signal containing current data from the capacitive proximity sensor 32a for the same preset period of time, as in step 83 (in this example, one second). The current data signal is then filtered in a second data filtering step 89, which is identical or similar to the data filtering step 84.

Once the current data signal is filtered, a second statistical calculation step 90 is performed on the current data signal to calculate a mean value and a variance value for the current data signal. This step is identical or similar to the statistical calculation step 85. Once these calculations are performed, the fraud detection process 82 proceeds to a second variance threshold analysis step 91. In this step, in a similar way to the variance threshold analysis step 86, the processor 36 determines if the current variance value is within the variance threshold.

If the current variance value is not within the variance threshold then the fraud detection process 82 discards the current data, the current mean value and the current variance value and returns to the current data receiving step 88. Conversely, if the current variance value is within the variance threshold the fraud detection process 82 proceeds to fraud detection step 92.

In the fraud detection step 92 the processor 36 determines if the absolute difference between the reference value stored in the storing reference value step 87 and the current mean value is greater than a mean threshold value. The mean threshold value is preset by an administrator of the fraud detection system 12.

If this difference is not greater than the mean threshold value the fraud detection process returns to the storing reference value step 87. Conversely, if this difference is greater than the mean threshold value the fraud detection process 82 proceeds to an alarm step 93 in which an alarm signal is generated. After an alarm signal is generated the fraud detection process loops back to the storing reference value step 87 and the current mean value is stored as the reference value. The loop will cycle through steps 87 to 93 until the fraudulent device is removed. When the fraudulent device is removed a second alarm signal will be generated.

The first alarm signal indicates that a fraudulent device is present at the ATM 10 and the appropriate actions are taken. In this embodiment, the appropriate action is to send the signal to the remote monitoring center 50 via the rf transceiver 34.

The second alarm signal indicates the foreign object is no longer present (either having been removed or fallen off). Generating the first and second alarm signals in this manner allows recording of the time period over which the fraudulent device was present. This allows the ATM owner to identify users of the ATM during the period when a fraudulent device was present, which may enable the ATM owner to prevent fraud against these ATM users.

It will be appreciated that the fraud detection process 82 is repeated at regular intervals not only for each capacitive proximity sensor 32, but for each of the different frequencies at which the sensors 32 operate. For example, if both sensors 32a,b operate at 13 MHz and 20 MHz, four instances of the fraud detection process 82 would share processing time on the processor 36.

Integrated Local ATM Embodiment

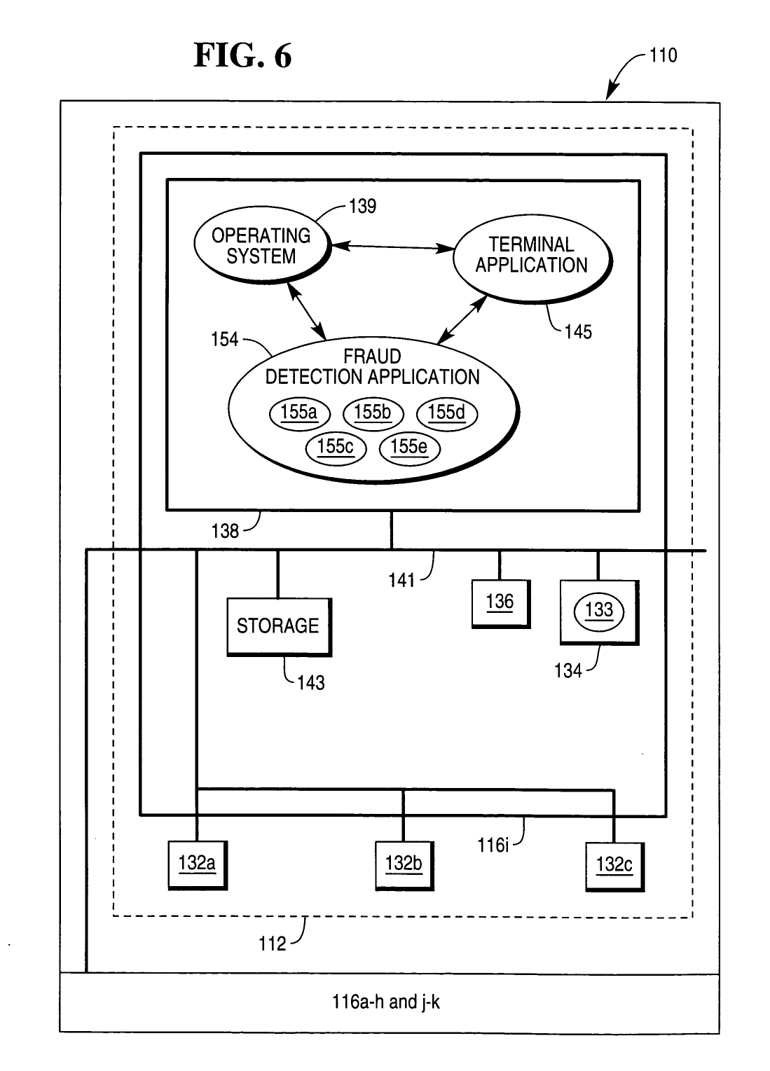

In the embodiment of FIGS. 1 to 5 the fraud detection system 12 was provided as a retro-fit kit; in this embodiment, a fraud detection system is incorporated into an ATM when it is manufactured or installed. In such embodiments, the fraud detection program is incorporated into ATM software executing on the ATM, and the normal communication facilities of the ATM may be used (either alone or in combination with a dedicated communications channel) to communicate suspected ATM fraud information to a remote center or to personnel, as now described in more detail with reference to FIG. 6.

FIG. 6 shows an ATM 110 including: a fraud detection system 112 which is an integrated part of an ATM 110 and includes a terminal controller 116i and sensors 132a-c, which are similar to the terminal controller 16i and sensors 32, respectively. The ATM 110 also includes ATM components 116a-h and 116j-k, which are identical to the components 16a-k and 16j-k of FIG. 1, respectively.

The terminal controller 116i comprises a BIOS 133 stored in non-volatile memory 134, a processor in the form of CPU 136, main memory 138 associated with the CPU 136, and a storage device 143 in the form of a magnetic disk drive, all of which are interconnected by a bus 141. On power up, the terminal controller 116i loads the following programs into the main memory 138: an operating system kernel 139, a terminal application 145 for controlling the ATM 110, and a fraud detection application 140 (similar to fraud detection program 40 of FIG. 2) for detecting fraud at the ATM 110.

The fraud detection application 140 performs the following operations: (i) controlling the operation of the sensors 132; (ii) monitoring output from the sensors 132; (iii) comparing the output from the sensors 132 to reference data; (iv) communicating with the terminal application 145; (v) updating the reference data; and (vi) raising an alarm when fraud is detected. These operations are discussed in further detail below.

In this embodiment, the fraud detection application 140 includes a plurality of routines 155 (which will be discussed in more detail below).

Associated with the fraud detection application 140 is reference data. Reference data is typically stored on the main memory 138 and corresponds to the output of the sensors 132 during operation of the ATM 110.

The reference data is indicative of conditions at the ATM 110. These conditions may relate to: (i) the general environment (such as lighting, background noise, presence, absence, or instance of a radio signal, vibration, and the time, the duration, the rate and/or the frequency at which any of these phenomena occur or change, and such like), and/or (ii) a specific environment (such as a card reader area of the ATM, a keypad area of the ATM, areas where cameras might be attached, areas near the cash dispenser output slot 116h, or such like), and/or (iii) a user environment (such as where a user may stand in relation to the ATM 110, which hand a user employs to enter information, any jewelry worn by the user on his or her hand that comes into proximity with the ATM 110, or such like), and/or (iv) the climatic environment (humidity, precipitation, sunshine, wind, and such like), and/or (v) a fraudulent environment (such as a false keypad, a third party reading device, and such like). The reference data allows the ATM 110 to compensate for normal conditions so that the ATM can differentiate between normal operation (for example, normal operation during a windy day, normal operation when a user is wearing large finger rings, and such like) and abnormal operation (for example, when a fraudulent device has been fitted to the ATM 110).

The reference data can be indicative of both normal conditions and abnormal conditions. For example, when a known fraud has been perpetrated, the reference data may indicate conditions that match those recorded when the known fraud was perpetrated. If there is a subsequent match to those recorded conditions for the known fraud, then this match may indicate that the known fraud is being perpetrated. Thus, conditions sensed during known frauds can be used as a template for detecting recurrence of the same fraud.

In this embodiment, the collated reference data is primarily derived from conditions that are indicative of normal operation of the ATM 110. Conditions that are indicative of normal operation may change over time, for this reason the reference data is dynamic to allow for such changes. Therefore, the fraud detection application 140 is provided with an updating routine 155a, whereby the effects of conditions such as normal use variations and normal environmental variations at the ATM 110 are detected by sensors 132 and the data output from these sensors in response to these variations is stored as reference data.

The updating routine 155a is called at preset intervals to update the reference data. This has the advantage that when the sensors 132 are monitoring the ATM 10 for fraud, normal use variations and normal environmental variations can be detected, learned and factored out (heuristically or otherwise).

The sensors 132 include, a capacitive keypad proximity sensor 132a (which monitors the encrypting keypad 116a), a capacitive card reader proximity sensor 132b (which monitors the card reader 116b), and an RF detector 132c.

Under the control of the terminal controller 116i the sensors 132 are operable to detect at different frequencies. The capacitance proximity sensors 132a and 132b can detect the presence of any material by scanning at the appropriate frequency. Certain material or objects are only detectable at certain frequencies (such as water which is detectable at low frequencies), so by scanning an area of the ATM 110 at a plurality of different frequencies it can be determined from the output of the sensors 132a-b if a foreign object is present on the area of the ATM 110 or if water is present on the area of the ATM 110.

The fraud detection application 140 receives data from each of the sensors 132 and compares this sensed data with reference data to determine whether fraud may be present.

The sensors 132a-b are positioned and operate in similar manner to the sensors 32a-b as shown in FIG. 3 and FIGS. 4A and 4B, respectively. Although in this embodiment as opposed to the embodiment of FIG. 2, the capacitive proximity sensors 132a-b are coupled to, controlled, and monitored by the terminal controller 116i.

The terminal controller 116i controls the capacitive proximity sensors 132 by using a scanning routine 155b to instruct the sensors to scan the sensed area at a particular frequency which is selected from a plurality of possible frequencies.

The terminal controller 116i receives data output from the sensors 132. This sensed data is monitored by a monitoring routine 155c in the fraud detection application 140 to determine if a foreign object has been detected, what frequency or frequencies it was detected at, and how long it has been present. The monitoring routine 155c then collates data corresponding to these determinations.

If a foreign object is detected, then the terminal controller 116i invokes a comparing routine 155d, which operates on the data collated by the monitoring routine 155c and compares it to the reference data. Based on the comparison of these two data sets the comparing routine 155d determines if the detected foreign object is indicative of fraud or some transient aberration.

If the foreign object is indicative of fraud, then the terminal controller 116i invokes an alarm routine 155e to alert a remote center to the possibility of fraud being perpetrated at that ATM 110.

It will also be appreciated that the disclosed fraud detection system 112 does not merely apply to capacitance sensing. There are many ways to automatically detect the presence of a solid object in an environment where the solid object was not previously present. For example, RF sensor 132c can be used to detect RF transmissions. Fraudulent devices placed at the ATM 110 by a fraudster may be operable to transmit data captured at the ATM back to a remote location via an RF transmitter. For example, a camera may be placed at the ATM 110 to capture images as a user enters his PIN into the keypad. The camera then transmits these images to the remote location via an associated transmitter coupled to the camera. The RF sensor 132c detects the signal from the camera and the terminal controller 116i determines that a foreign object is present at the ATM 110. However, a public space around an ATM 110 may be cluttered with many RF signals, many of which are consistent with valid usage of the ATM 110 and normal environmental variations (for example, cellular telephones transmit RF signals). For this reason, knowing that a foreign object is transmitting an RF signal is of little value.

To determine the validity of a detected RF signal, reference data pertaining to various parameters of the RF signal are collected and processed. These parameters include, inter alia, the strength of the signal, duration of the signal, the time of day detected, frequency of the signal, and the consistency with which these parameters occur. Operating on the reference data and the sensed data relating to the detected foreign object, the terminal controller 116i determines the validity of the detected foreign object.

It will be appreciated that the sensors 132 discussed may be used simultaneously, resulting in greater reliability and confidence when determining if fraud is present at the ATM 110. Sensors can be selected on the basis of what they are trying to detect. For example, if a card skimming device is detected (through capacitance sensing or otherwise) and a camera is also detected (through RF transmission detection or otherwise), then the likelihood of fraud being committed is greater than if only one type of sensor was used. Therefore, in such cases a high alert level or immediate ATM 110 shutdown can be implemented. Other alerts and associated actions can also be activated due to other combinations of sensing conditions through smart algorithms executed by the terminal controller 116i.

Distributed Network Embodiment

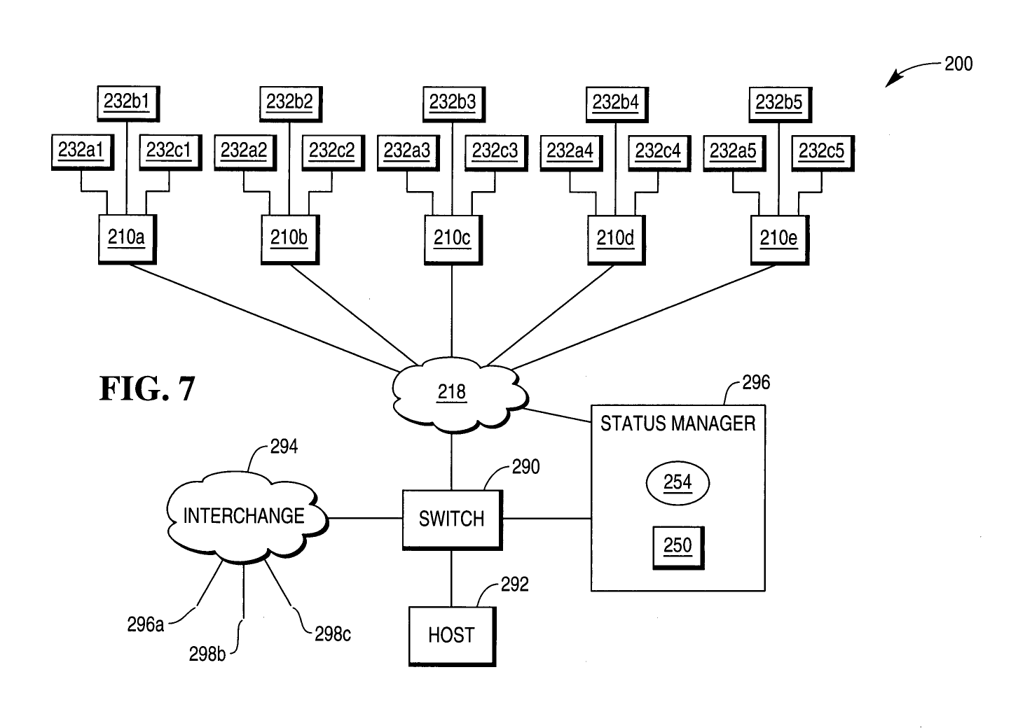

In the embodiment of FIGS. 1 to 6 the fraud detection system resided locally at each ATM (such that it is either retrofitted subsequent to the installation of the ATM or it is incorporated into an ATM during the manufacturing or installation process); in this embodiment, a fraud detection system is distributed across an ATM network. In such embodiments, a portion of the fraud detection program executes on each of a plurality of ATMs in the network and another portion of the program executes elsewhere on the ATM network, such as a remote monitoring center, as now described in more detail with reference to FIG. 7.

FIG. 7 shows an SST network 200 which includes a plurality of SSTs 210a-e. In this embodiment, each SST 210 is an ATM.

Each ATM 210 is coupled by a network 218 to a transaction switch 290, which can route transactions to a host 292 for authorization of “on us” transactions, an interchange 294 for a “not on us” transaction, and a status manager 296.

An “on us” transaction is a transaction involving an account managed by a financial institution (or other entity) that owns (or manages) the ATM network. A “not on us” transaction is a transaction involving an account managed by a financial institution (or other entity) that is different from the financial institution that owns the ATM network. As a result, a “not on us” transaction needs to be routed to a different network for the transaction to be authorized. The interchange 294 routes the transaction to the appropriate financial institution or other entity that will authorize the transaction.

The status manager 296 is also coupled directly to the network 218 for direct communication with each ATM 210. The ATM network 200 also includes a fraud detection system, though unlike the fraud detection system 12 and 112 that wholly reside at the ATM, the fraud detection system is distributed across the ATM network 200. Part of the fraud detection system is located at the ATMs 210 and part is located in the status manager 296.

Each ATM 210 is equipped with sensors 232a-c that are identical or very similar to sensors 32a-b and 132a-c. In a similar way as the embodiments of FIG. 2 and 6, the sensors 232a-c receive inputs in the vicinity of the ATMs in which they are located.

The host 292 is a transactional server operated by the same entity that manages the ATMs 210. The interchange 294 is a network that links to the transactional servers of various other entities who provide financial services. Communication paths 298a-c connect switch 290 to these various other entities via interchange 294. For example communication paths 298a-c provide a communication path to Bank A, Credit Card Company B, and Credit Union C, respectively.

In operation the host 292 receives the first communication whenever a user initiates a transaction at any of the ATMs 210. If the user is a customer of the entity who manages that ATM (i.e. an “on us transaction”) the host 292 will process the user's transaction. If the user is a customer of a different entity (i.e. a “not on us transaction”) the host 292 will redirect the communication to the proper transactional server via the interchange 294.

The status manager 296 includes one or more servers that are programmed with various ATM monitoring applications and it is linked directly to each of the ATMs 210. The status manager 296 is operable to monitor and communicate with each of the ATMs 210 directly (i.e. without being routed through switch 290). One of the ATM monitoring applications executing on the status manager 296 is a fraud detection application 240 for detecting fraud at any of the ATMs 210, similar to the fraud detection application 46 discussed above.

Associated with the fraud detection application 240 is reference data that is identical or similar to the reference values and/or reference data discussed in relation to FIG. 5 and FIG. 6, respectively. This reference data is typically stored at the status manager 296 and corresponds to the output of the sensors 232 during operation of the ATMs 210.

The fraud detection application 240 is operable to receive data from each of the sensors at each of the ATMs 210 and compares this sensed data with reference data to determine whether fraud may be present. The fraud detection application 240 may implement other fraud management operations, such as analyzing transactions to determine if they indicate the possibility of fraud. One type of analysis may determine how frequently withdrawals are made from an account, for example, if the same account has a sum of money withdrawn from it on multiple occasions within a short time period (e.g. within one hour) at multiple ATMs, then this may indicate fraud. Another example of transaction analysis is to determine if an account is being debited within a short time period at multiple locations, each separated by a large distance (for example, each in different countries). The fraud detection application 240 may also be operable to receive new fraud detection criteria transmitted across a network from a remote host. This would enable a new type of fraud to be counteracted very quickly by deploying a solution automatically across a network.

Various modifications may be made to the above described embodiments, within the scope of the present invention.

In some embodiments, the sensors may be used in conjunction with a camera directed towards the user interface so that when the sensors detect a foreign object the camera captures an image of that part of the user interface in which the object was detected. The captured image may then be relayed to a remote control center for review by security personnel. Using this system enables a single person located in the control center to monitor a network of ATMs. Moreover, if an ATM is taken out of service due to a false alarm, a remote operator may be able to confirm from the captured image that it was a false alarm, and restore the ATM to service.

In one of the above embodiments, one of the sensors was an integral part of a data capture device, but in other embodiments a data capture device may be retrofitted with a sensor. In such embodiments the sensor may have either a dedicated processor for operating on received data and for performing the specific functions of the sensor, or be controlled by the terminal controller of an ATM.

In some embodiments, the processor of the fraud detection system may generate a number indicating the probability that a fraudulent device is present, while in other embodiments the processor generates a number indicating whether a detected foreign object is valid or invalid, where an invalid foreign object indicates that a fraudulent object may be present.

Any of a variety of standard port configurations may be used for coupling the fraud detection card 30 to the ATM.

In the embodiment of FIG. 2, a communications port served as a power adapter and a communications path, however, it should be appreciated that in other stand alone embodiments the fraud detection system may be provided with a separate power supply and in such embodiments the communications port is not required.

In the embodiment of FIG. 2, a cellular radio frequency transceiver was used to implement a dedicated communications channel, though in other embodiments the dedicated communications channel can be implemented with any convenient wire or wireless device.

In the embodiment of FIG. 2, the transmitting channels 44a₂ and 44b₂ may be used to connect additional sensors to the card 30. Due to the two to one ratio between transmitting channels 44 and receiving channels 45, when additional sensors are used the receiving channels 45 will be connected to more than one sensor. For example, if transmitting channels 44a₂ is used to transmit a signal to the additional sensor, receiving channel 45a will be used to receive signals from both the additional sensor and the sensor 32a. Therefore, when either transmitting channel 44a₂ or 44b₂ is used the signal handling circuitry 43 uses time division multiplexing to handle the additional signals being received by the receiving channels 45.

In the above embodiments the fraud was discussed in reference to SSTs that utilize cards for an identification token, however, the fraud detection system of the present invention is equally applicable to combat fraud that attacks SSTs employing RFID transceivers, a biometric reader (for example, the voice, fingerprint, iris pattern, or DNA of a user), or any other suitable means to identify the user or to claim an identity for the user.

The above embodiments used capacitance proximity sensors and/or RF sensors, however, in other embodiments other types of sensors may be used, including sensors that monitor reflection of a radiated signal (for example, light, ultrasonic, sound and such like), attenuation/blocking of a transmitted signal (for example, light, and sound and such like), change of physical properties (for example, mass, volume, dimensions and such like), change of a field (for example, magnetic field, electric field, and such like), some other change to a measurable parameter (for example, temperature, pressure and such like), or detection of radiation from the object (for example, heat, light, and such like). Specific examples of other types of sensors include: an optical proximity sensor (for example, infrared); an inductive proximity sensor; an ultrasonic proximity sensor; a thermal sensor; a magnetometer; a vibration sensor (for example, a vibrometer, a strain gauge, accelerometer, and such like). These sensors may be incorporated into embodiments of the fraud detection system.

In some embodiments, some of the user interface components may be mounted on the fascia instead of in the housing.

In other embodiments, the fraud detection application may be an integral part of the terminal application.

In the above embodiment, an SST in the form of an ATM is described; however, in other embodiments different types of SSTs may be used, such as: postal service kiosks for allowing a user to weigh letters and parcels and purchase postage for the weighed letters and parcels; non-cash kiosks that allow users to access information (for example, to view reward points on a reward card the user inserts into the SST); check-in kiosks such as those that allow users to check in at airlines and hotels; kiosks that accept payment for services (for example, Web surfing kiosks, kiosks that allow users to buy goods, and such like); point-of-sale devices that allow customers to purchase goods at stores without cashier assistance, such as those found in grocery stores; as well as vending machines that dispense, for example, candy bars and drinks.

In some embodiments, the fraud detection application may include an algorithm that determines if a foreign object is detected for longer than a predetermined length of time (for example, one minute) to determine if a detected foreign object is transient.

The fraud detection application 140 may include one or more security procedures. One security procedure may request the terminal controller 116i to shut down the ATM so that it is no longer in service. Another security procedure may request the terminal controller 116i to relay a message to a remote center to inform the center of a possible fraud being perpetrated against the ATM. Yet another security procedure may involve the ATM in capturing details of the user for audit purposes. One security procedure may evaluate the probability of a fraud being perpetrated, and when the probability is higher than a predetermined value, the security procedure may request that the terminal controller 116i send an alert signal to a remote center via the external network and allow the remote center to decide on the appropriate action to be taken. For instance, a person could be dispatched to go inspect the ATM. Similarly, when the probability is less than a predetermined threshold then the terminal controller 16i takes no action at all.

One security procedure may request the journal printer to record that a suspected fraud had occurred.

The structures discussed for the fraud detection application are only examples of how such an application may be implemented. In other embodiments, the routines may be objects, agents, or any other convenient structure for implementing the functions described above.

In some embodiments the reference data is stored in the main memory, though in other embodiments the reference data is stored on a storage device, such as a magnetic disk drive, and is loaded into the main memory when accessed. Likewise, reference data may be stored at the processor or CPU on an onboard memory or cache to facilitate quick access by the processor.

In some embodiments, some of the reference data is preprogrammed into reference files as part of the fraud detection application. These reference files can also be updated by the fraud detection application. For example, the reference data may be collated by the fraud detection application and then stored in the reference files, or it may be updated by a remote server via a network. In some embodiments, the reference files are updated by both of these sources.

In some embodiments, the reference data is volatile and in others the reference data is persistent.

It will now be appreciated that this embodiment of the invention has the advantage that multiple sensors can be used to determine whether fraud is being perpetrated, and these multiple sensors provide richer information from which an accurate determination can be made.

In the embodiment of FIG. 7 the ATMs 210 may be managed (that is, owned and/or operated) by the same entity or a plurality of entities (an entity may be a corporation, a partnership, a sole trade, or such like). For example in some instances ATM 210a and ATM 210b are both managed by Entity A, while in other instances ATM 210a and ATM 210b will be managed by Entity A and Entity B, respectively. In the latter case customers of Entity A may still utilize ATM 210b. In the above embodiment, each of the ATMs 210a-e is managed by the same entity.

In the embodiments discussed above the reference data is stored at a status manager or an ATM, though in other embodiments the reference data may be stored at any convenient location on the network, including the host 292 or distributed across one or more ATMs 210

What is claimed is:

1. A self-service terminal (SST) comprising:
a first sensor for sensing a first condition at the SST;
a second sensor for sensing a second condition at the SST;
a memory for storing reference data indicative of conditions at the SST, where at least some of the stored reference data is indicative of conditions during normal operation; and
a processor coupled to the first sensor, the second sensor and the memory, where the processor is operable to
(i) receive data from the sensors,
(ii) retrieve the reference data from the memory, and
(iii) compare the received data with the reference data to determine if the received data is indicative of abnormal conditions.

2. A self-service terminal according to claim 1, wherein the abnormal conditions indicate that fraud may be suspected.

3. A self-service terminal according to claim 1, wherein the processor is further operable to execute a security procedure in response to determining that the captured data is indicative of abnormal conditions.

4. A self-service terminal according to claim 3, wherein the processor selects the security procedure from a plurality of security procedures.

5. A self-service terminal according to claim 1, wherein the processor is further operable to alert a remote control center when the captured data is indicative of abnormal conditions.

6. A self-service terminal according to claim 1, wherein the processor is further operable to deactivate the self-service terminal when the captured data is indicative of abnormal conditions.

7. A self-service terminal according to claim 1, wherein the processor is further operable to capture and relay an image of a part of the terminal in proximity to the sensor that captured the data indicative of abnormal conditions.

8. A self-service terminal according to claim 1, wherein the first sensor is selected to detect a specific type of object.

9. A self-service terminal according to claim 1, wherein the second sensor is tuned to detect a specific type of metal.

10. A self-service terminal according to claim 1, wherein one of the first sensor and the second sensor is operable to scan the self-service terminal at a plurality of frequencies to capture data indicative of a range of materials and conditions.

11. A method of detecting operating conditions at a self-service terminal, the method comprising the steps of:
monitoring an environmental condition of the self-service terminal using a plurality of sensors;
receiving data from the plurality of sensors; and
comparing the received data with reference data to determine the probability that the monitored environmental condition is indicative of fraud.

12. A method according to claim 11, wherein the step of comparing the received data with reference data, further comprises the step of factoring out any data that is indicative of normal use.

13. A method according to claim 11, wherein the step of comparing the received data with reference data, further comprises the step of factoring out any data that is indicative of normal environmental variations.

14. A method according to claim 11, wherein the reference data at least partly comprises data indicative of environmental conditions previously received by the plurality of sensors.

15. A method according to claim 11, further comprising the step of selecting a security protocol based on the probability that the monitored environmental condition is indicative of fraud.

16. A self-service terminal (SST) comprising:
a sensor for sensing a condition at the SST;
a memory for storing criteria indicative of expected conditions at the SST, where the criteria includes characteristics associated with normal conditions and characteristics associated with abnormal conditions; and
a processor coupled to the sensor and the memory and operable to (i) receive data from the sensor, (ii) evaluate the sensed data with respect to the criteria to determine if the sensed data is indicative of abnormal conditions; and (iii) alert the SST in the event that abnormal conditions are detected.
